(19) United States
(12) Patent Application Publication
(10) Pub. No.: US 2014/0137952 A1
(43) Pub. Date: May 22, 2014

(54) SUPPORT RACK

(71) Applicant: CHEN-SOURCE INC., Taoyuan County (TW)

(72) Inventor: Wei-Ting LIN, Taoyuan County (TW)

(73) Assignee: CHEN-SOURCE INC., Taoyuan County (TW)

(21) Appl. No.: 13/680,784

(22) Filed: Nov. 19, 2012

(51) Int. Cl. F16M 13/00; F04B 39/12

(52) U.S. Cl. CPC F16M 13/00; F04B 39/12
USPC 137/343; 248/558

(57) ABSTRACT

A support rack includes a rack body providing a locating groove, two coupling structures, a hinged stop plate and transverse positioning grooves, a U-shaped support bar having two axle-shaped end portions respectively pivotally coupled to the coupling structures for supporting a tablet PC in one of a series of tilted positions to let the tablet PC be stopped against the stop plate or selectively positioned in one of the transverse positioning grooves, and a fan module mounted in the rack body for cooling the tablet PC, ultrabook or notebook being used with the support rack.

### BACKGROUND OF THE INVENTION

1. Field of the Invention

The present invention relates to a mobile electronic device support design and more particularly, to a support rack, which can be used to support a notebook or ultrabook in horizontal, or a tablet PC in one of a series of tilted positions.

2. Description of the Related Art

With fast development of electronic and multimedia technology, a variety of advanced mobile electronic products, such as notebook, tablet PC, smart phone, and etc. have been created and can be seen anywhere. For the advantages of small size, light weight, high mobility and versatile functions, notebook computer, tablet computer and ultra-book exhibit a significant increase in sales in the market.

However, when using a mobile electronic device outdoors or when sitting on a chair to use a mobile electronic device, people may hold the mobile electronic device with the hand or place the mobile electronic device on the laps. If a user holds a mobile electronic device with the hand and uses it for a long period of time, or clicks on the keyboard of a notebook on the laps for a long period of time, the user's hand will get tired or injured, or suffer from carpal tunnel syndrome. Further, the temperature of a mobile electronic device will rise after a long use. Supporting a mobile electronic device on the laps will cause the laps to feel uncomfortable due to hot temperature. Further, there are commercial support racks adapted for supporting a mobile electronic device on a deck or table, or the user's laps steadily. However, commercial support racks are specifically designed for supporting a single type of mobile electronic devices. A conventional support rack designed for supporting a notebook or ultrabook is not practical for use to support a tablet PC. People may have to buy different support racks for different applications. Using support racks in this manner is not cost-effective.

Therefore, there is a strong demand for support rack for mobile electronic device that eliminates the aforesaid problems.

### SUMMARY OF THE INVENTION

The present invention has been accomplished under the circumstances in view. It is the main object of the present invention to provide a support rack, which is practical for use with a notebook or ultrabook, as well as a tablet PC. It is another object of the present invention to provide a support rack, which allows adjustment of the tilting angle of the supported tablet PC. It is still another object of the present invention to provide a support rack, which can cool the supported mobile electronic device.

To achieve these and other objects of the present invention, a support rack comprises a rack body, and a support bar. The rack body comprises a base member. The base member comprises opposing inner wall and outer wall, at least one coupling structure located at the outer wall, a locating groove located at the outer wall at a front side relative to the at least one coupling structure, first positioning means disposed in a middle part of the locating groove, and second positioning means located at the outer wall near a rear side thereof. The support bar is receivable in the locating groove of the rack body, comprising at least one axle-shaped end portion respectively pivotally coupled to the at least one coupling structure and turnable relative to the rack body in and out of the locating groove of the rack body for supporting a mobile electronic device in a tilted position to let the mobile electronic device be selectively stopped against one of the first positioning means and the second positioning means.

Further, the outer wall of the base member of the rack body is a recessed wall sloping down from a back side of the base member toward a front side of the base member. Thus, when a notebook or ultrabook is positioned in the recessed outer wall of the base member, the user can click on the keyboard of the notebook or ultrabook comfortably.

Further, the base member of the rack body is covered with a shock-absorbing cushion layer. When placing the support rack on the laps to support a notebook or ultrabook, the shock-absorbing cushion layer of the base member is kept in direct contact with the laps, rendering enhanced comfort.

Further, a fan module is mounted in a recessed accommodation space at the rack body. The fan module comprises a fan bracket mounted in the recessed accommodation space of the rack body, and an electric fan mounted in the fan bracket. The electric fan comprises a power cable extending out of the fan bracket and terminating in an electrical plug connector. When using the support rack with a mobile electronic device, the electrical plug connector of the power cable of the electric fan can be connected to a power jack of the mobile electronic device for power input so that the electric fan an induces currents of air to cool the mobile electronic device.

### BRIEF DESCRIPTION OF THE DRAWINGS

FIG. 1 is an elevational view of a support rack in accordance with the present invention.

FIG. 2 is an exploded view of the support rack in accordance with the present invention.

FIG. 3 corresponds to FIG. 2 when viewed from another angle.

FIG. 4 is a sectional side view of the support rack in accordance with the present invention.

FIG. 5 is schematic exploded view, in an enlarged scale, of a part of the present invention, illustrating the relationship between the axle-shaped end portion of the support bar and the respective coupling structure of the rack body.

FIG. 6 is a sectional elevation, in an enlarged scale, of a part of the present invention, illustrating the axle-shaped end portion of the support bar coupled to the respective coupling structure of the rack body.

FIG. 7 is a schematic drawing illustrating an application example of the present invention.

FIG. 8 is a schematic sectional view of the present invention, illustrating the angular position of the support bar adjusted relative to the rack body.

FIG. 9 is a schematic drawing illustrating another application example of the present invention.

FIG. 10 is a schematic drawing illustrating still another application example of the present invention.

### DETAILED DESCRIPTION OF THE PREFERRED EMBODIMENT

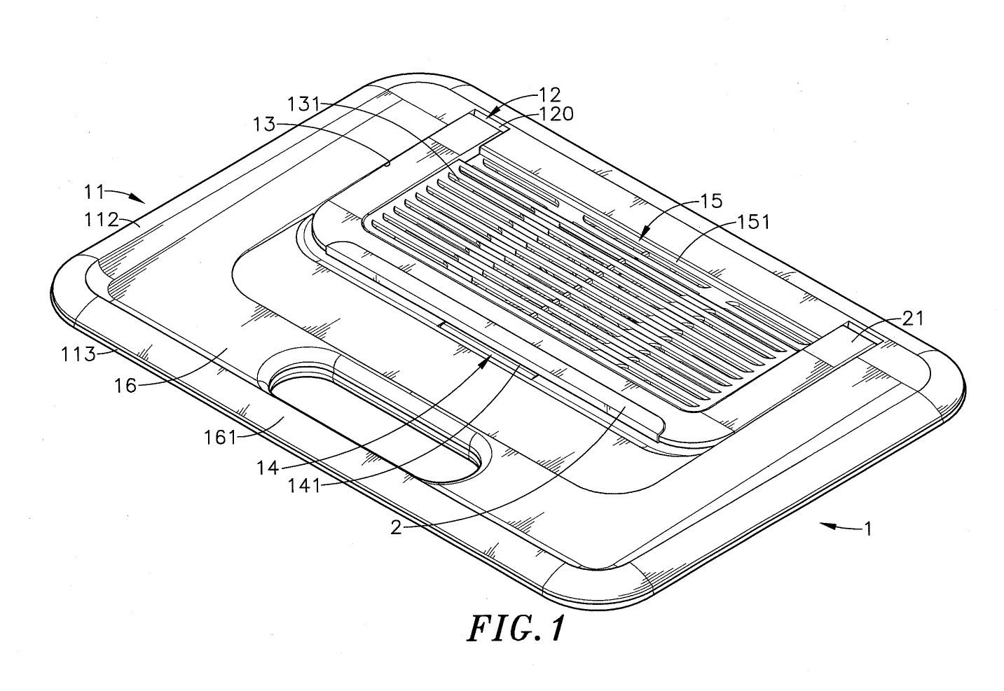

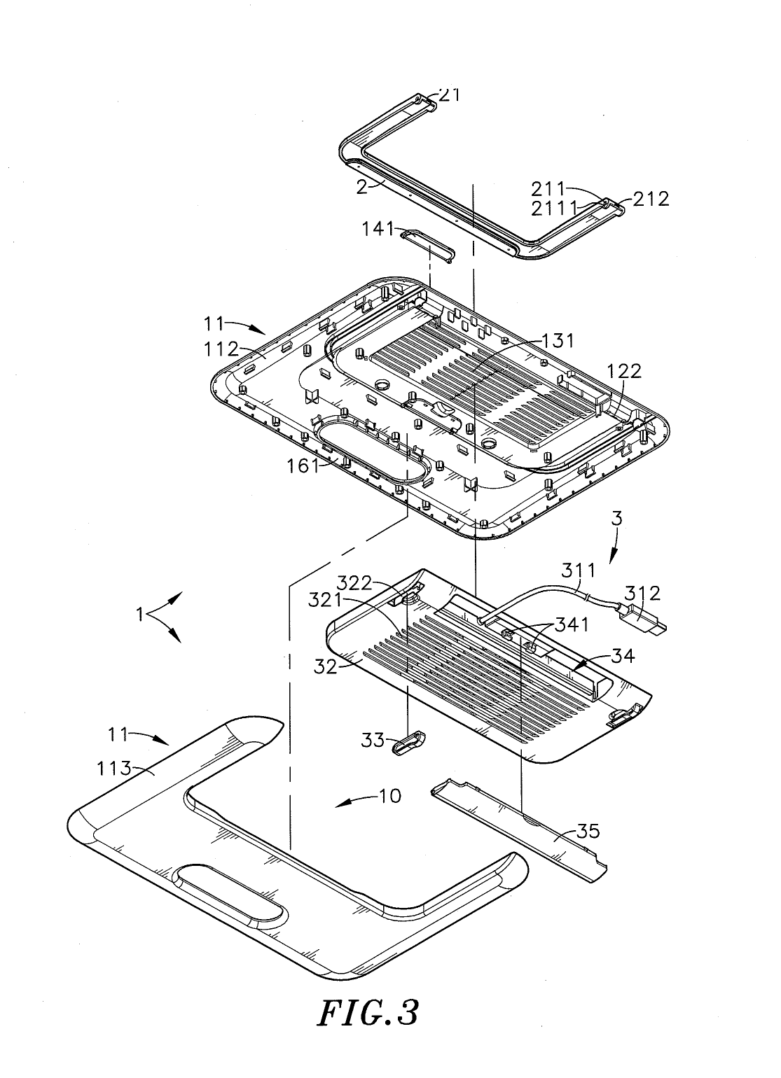

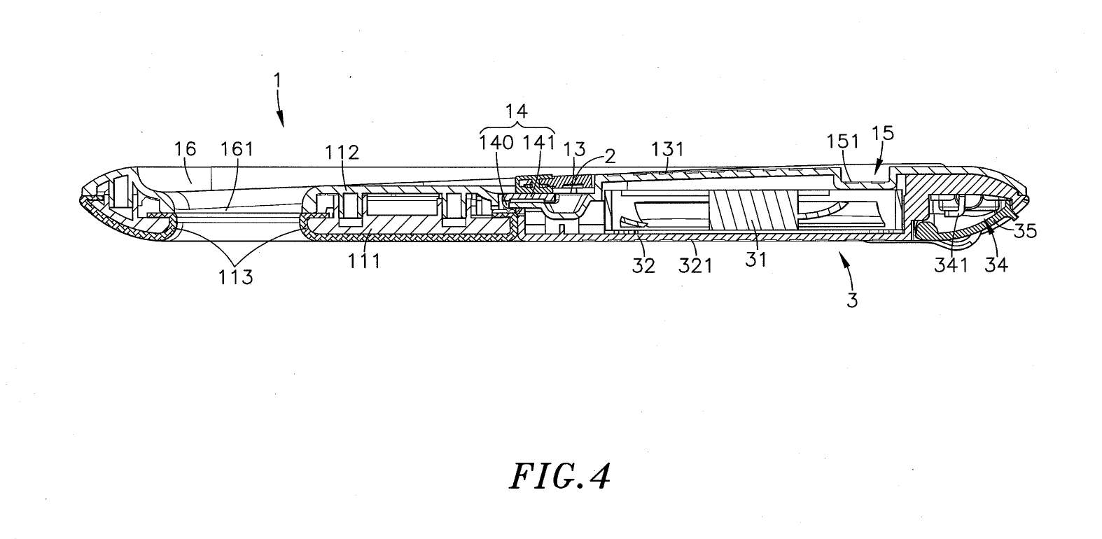

Referring to FIGS. 1-4, a support rack in accordance with the present invention is shown comprising a rack body 1, a support bar 2, and a fan module 3.

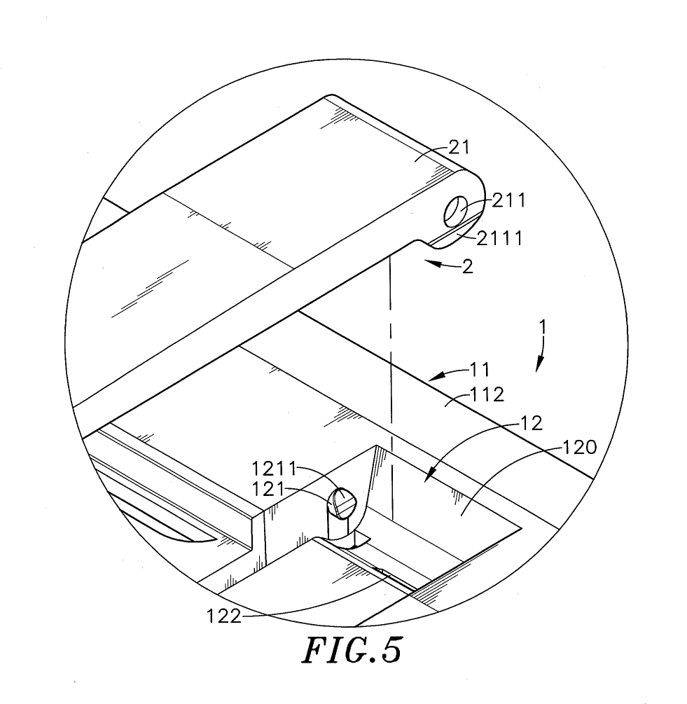

The rack body 1 comprises a base member 11 consisting of a bottom panel 111 and a cover panel 112. The cover panel 112 comprises a substantially U-shaped locating groove 13 located at an outer wall thereof, a coupling structure 12 located at each of two distal ends of the U-shaped locating groove 13, first positioning means 14 located at a middle part of the U-shaped locating groove 13, second positioning means 15 spaced between the two distal ends of the U-shaped locating groove 13, and a plurality of air vents 131 cut through opposing outer wall and inner wall thereof and surrounded by the U-shaped locating groove 13 between the first positioning means 14 and the second positioning means 15. Each coupling structure 12 comprises an axle groove 120 transversely located at one end of the U-shaped locating groove 13, two stub pivot rods 121 respectively suspending in the axle groove 120 at two opposite ends thereof and facing toward each other, and a retaining hole 122 disposed in the bottom side of the axle groove 120 (see FIG. 5). Each stub pivot rod 121 has a beveled guide face 1211 at the free end thereof.

Further, the bottom panel 111 of the base member 11 is a substantially U-shaped plate member, defining with the inner wall of the cover panel 112 a recessed accommodation space 10 for accommodating the fan module 3. The first positioning means 14 comprises a positioning recess 140 located at the middle part of the U-shaped locating groove 13, and a stop plate 141 hinged to the outer wall of the cover panel 112 and movable relative to the cover panel 112 between a received position where the stop plate 141 is received in the positioning recess 140 in flush with the bottom side of the U-shaped locating groove 13, and an extended position where the stop plate 141 is disposed outside the positioning recess 140 and kept at a predetermined angle, for example, right angles relative to the outer wall of the cover panel 112. The second positioning means 15 comprises a plurality of transverse positioning grooves 151 located at the outer wall of the cover panel 112 and spaced from the first positioning means 14 at different distances. Further, the outer wall of the cover panel 112 is a recessed wall 16 that slopes down from a back side toward a front side thereof. The base member 11 of the rack body 1 further comprises a grip 161 disposed at the front side of the recessed wall 16.

The bottom panel 111 of the base member 11 is covered with a cushion layer 113 that can be selected from the group of high elastic breathing fabric, ethylene vinyl acetate (EVA), polyurethane (PU), silicon rubber, and other shock absorbing materials that can offer the user enhanced touch comfort and non-slip safety.

The support bar 2 is a substantially U-shaped flat bar receivable in the U-shaped locating groove 13, comprising an axle-shaped end portion 21 at each of the two distal ends thereof, a locating rib 212 protruded from each axle-shaped end portion 21, an axle hole 211 transversely extending through each axle-shaped end portion 21, and two beveled guide faces 2111 respectively located at two opposite lateral sides of each axle-shaped end portion 21 at a bottom side relative to the associating axle hole 211 and fitting the beveled guide faces 1211 of the stub pivot rods 121 of the coupling structures 12 at the cover panel 112 of the base member 11 of the rack body 1.

The fan module 3 comprises a fan bracket 32 mounted in the recessed accommodation space 10 at the base member 11 of the rack body 1, and an electric fan 31 mounted in the fan bracket 32 and affixed thereto with, for example, screws. The electric fan 31 comprises a power cable 311 extending out of the fan bracket 32 and terminating in an electrical plug connector 312 that is electrically connectable to an external power source for power input. The fan bracket 32 comprises a plurality of elongated air vents 321 transversely arranged around the electric fan 31, two coupling holes 322 bilaterally located at the back side thereof, two foot members 33 respectively pivotally mounted in the coupling holes 322 and movable in and out of the respective coupling holes 322 between an operative position and a non-operative position, an accommodation open chamber 34 located at the back side thereof between the two coupling holes 322 for accommodating the power cable 311 and the electrical plug connector 312, a plurality of hooks 341 disposed in the accommodation open chamber 34 for securing the power cable 311 and the electrical plug connector 312 in place, and a pivoted lid 35 movable to close and open the accommodation open chamber 34.

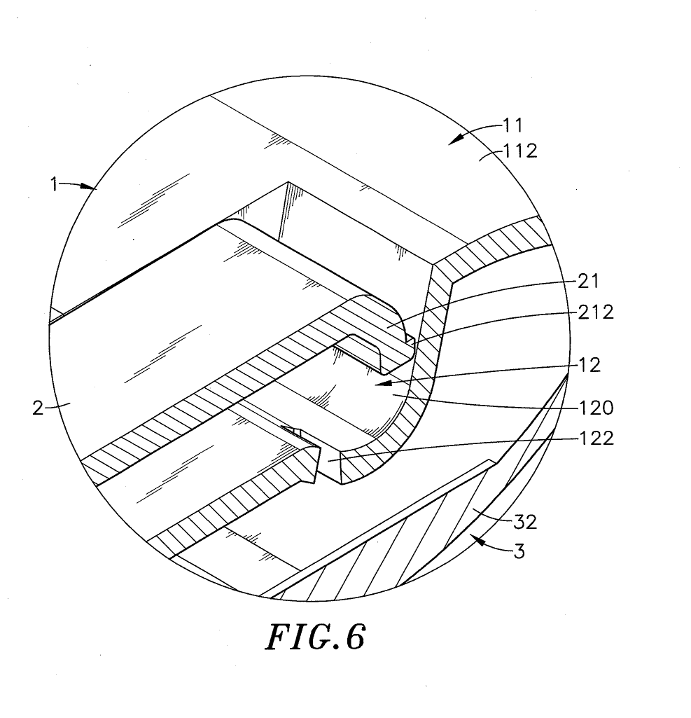

Referring to FIGS. 5 and 6, the two axle-shaped end portions 21 of the support bar 2 are respectively pivotally coupled to the coupling structures 12 of the rack body 1. When coupling the axle-shaped end portions 21 to the respective coupling structures 12, attach the beveled guide faces 2111 of the axle-shaped end portions 21 to the beveled guide faces 1211 of the stub pivot rods 121 of the coupling structures 12, and then force the axle-shaped end portions 21 downwardly toward the respective axle grooves 120 to move the beveled guide faces 2111 over the respective beveled guide faces 1211 and the respective axle holes 211 into coupled with the respective stub pivot rods 121. After coupling between the axle-shaped end portions 21 of the support bar 2 and the stub pivot rods 121 of the coupling structures 12 of the rack body 1, the support bar 2 can be turned relative to the rack body 1 in and out of the U-shaped locating groove 13 within a predetermined range. When received in the U-shaped locating groove 13, the support bar 2 is kept in flush with the outer wall of the rack body 1, minimizing the height of the support rack. Thus, the support rack has a low profile characteristic.

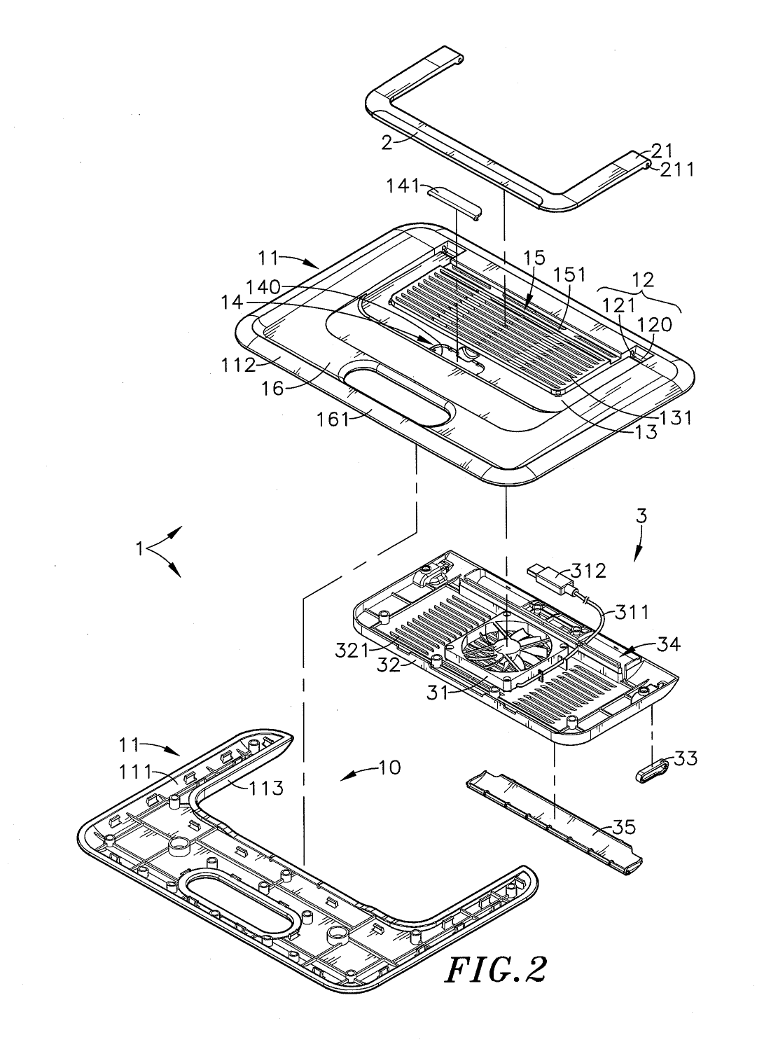

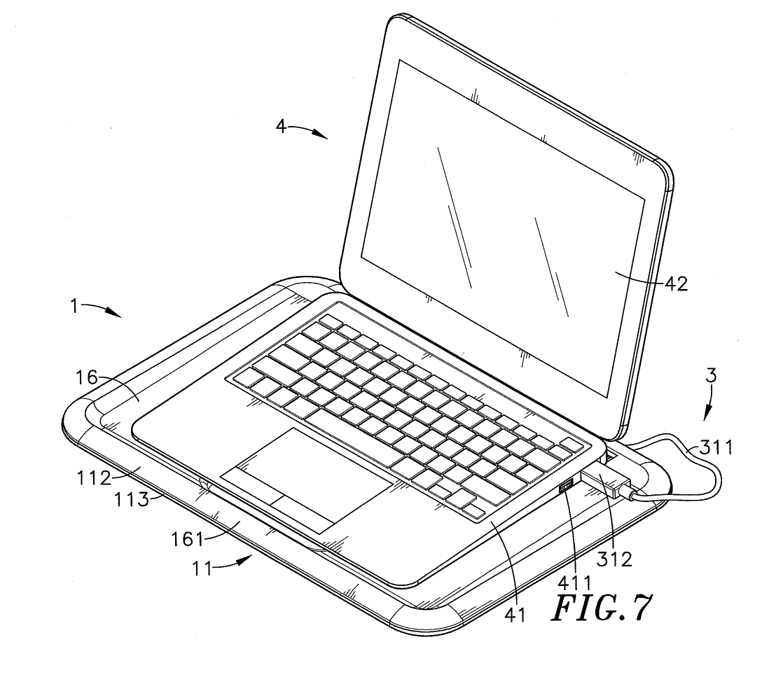

Referring to FIG. 7 and FIGS. 2 and 4 again, the support rack can be placed on a desk or table, or the user's laps to hold a mobile electronic device 4. When using the support rack with a mobile electronic device 4, for example, ultrabook, the user can turn the two foot members 33 out of the respective coupling holes 322 to the operative position to support the rack body 1 on a desk or table in a tilted position so that the user can click on the keyboard of the ultrabook at the recessed wall 16 of the base member 11 of the rack body 1 comfortably. Alternatively, the foot members 33 can be received in the respective coupling holes 322, and the rack body 1 can be placed on the laps to keep the shock-absorbing cushion layer 113 of the base member 11 in direct contact with the laps, rendering enhanced comfort.

Further, when using the support rack with a mobile electronic device 4, pull the power cable 311 of the electric fan 31 out of the accommodation open chamber 34 of the fan bracket 32, and then connect the electrical plug connector 312 to a power jack 411 of a body member 41 of the mobile electronic device 4. During operation of the electric fan 31, outside cooling air is drawn upwardly through the elongated air vents 321 of the fan bracket 32 toward the air vents 131 of the base member 11 of the rack body 1, causing circulation of air through the support rack and simultaneously carrying waste heat away from the bottom side of the mobile electronic device 4 to lower the temperature of the mobile electronic device 4.

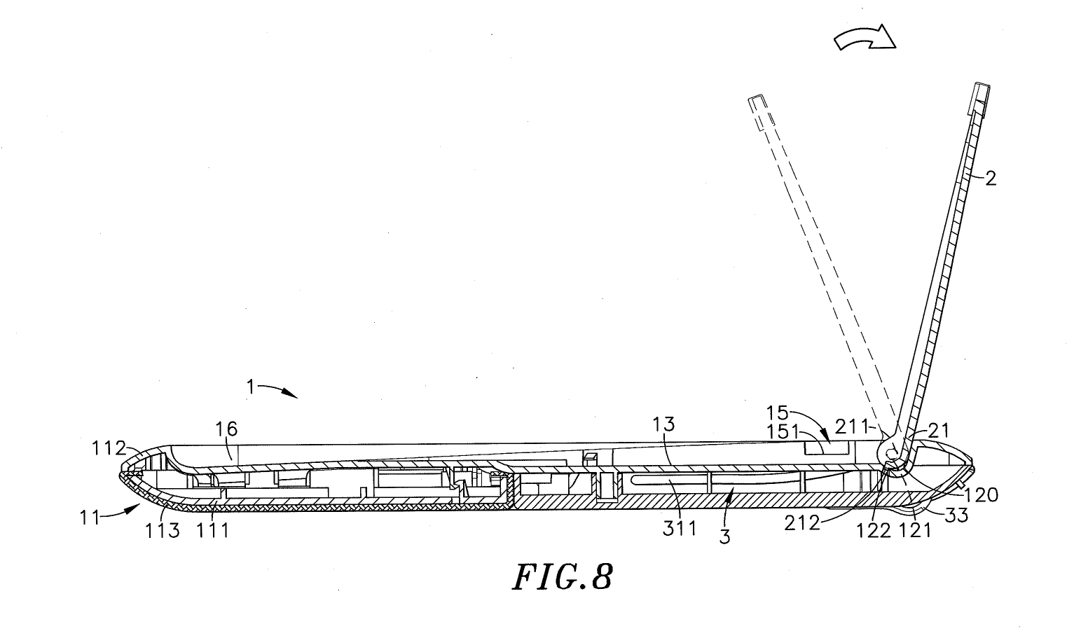

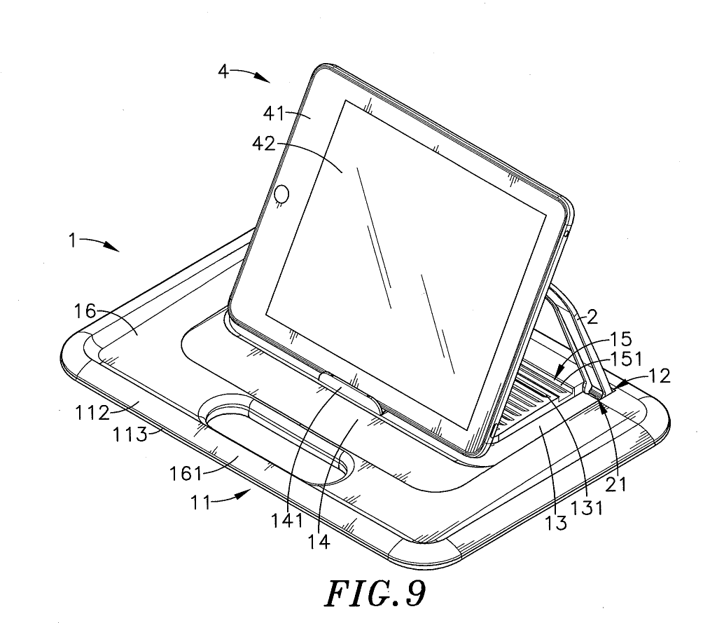

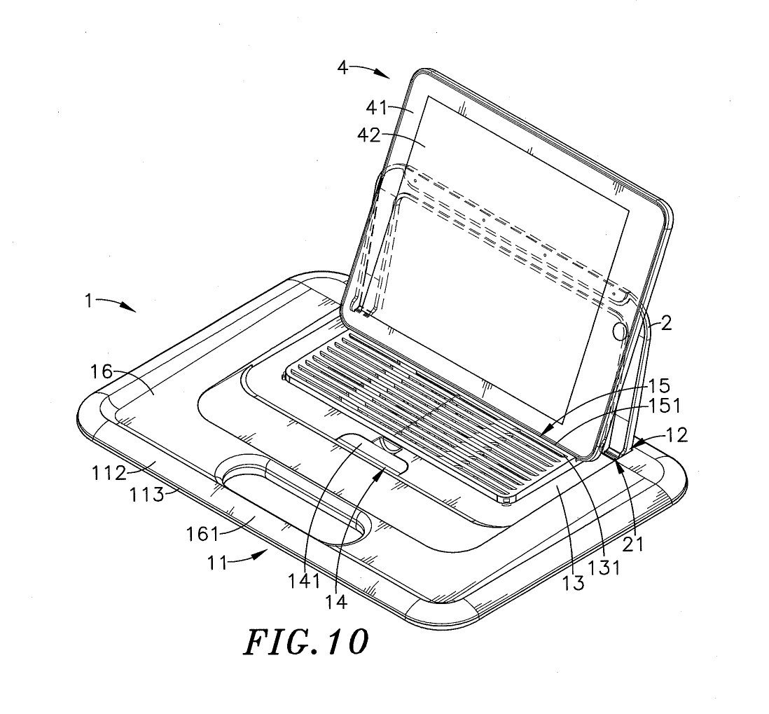

Referring to FIGS. 8-10, if the mobile electronic device 4 is a tablet computer, the user can turn the support bar 2 about the stub pivot rods 121 of the coupling structures 12 of the rack body 1 to the outside of the U-shaped locating groove 13 to force the locating ribs 212 at the respective two axle-shaped end portions 21 into engagement with the retaining holes 122 of the respective coupling structures 12 of the rack body 1 to support the mobile electronic device 4 in a slightly backwardly tilted position (see FIG. 10). Alternatively, the stop plate 141 can be turned out of the positioning recess 140, and the body member 41 of the mobile electronic device (tablet computer) 4 can be rested on the recessed wall 16 of the base member 11 of the rack body 1 with its front bottom side stopped against the stop plate 141 and its back side supported on the support bar 2 outside the U-shaped locating groove 13. At this time, the user can adjust the angular position of the support bar 2 relative to the base member 11 of the rack body 1 to change the tilting angle of the mobile electronic device (tablet computer) 4 (see FIG. 9), so that the user can viewing the display screen 42 of the mobile electronic device (tablet computer) 4 comfortably. Further, the user can selectively position the bottom edge of the body member 41 of the mobile electronic device (tablet computer) 4 in the transverse positioning grooves 151, and use the support bar 2 to support the mobile electronic device (tablet computer) 4 in one of a series of tilted positions.

Further, the aforesaid mobile electronic device 4 can be a notebook computer, ultrabook or tablet computer that can be placed horizontally in the recessed wall 16 of the base member 11 of the rack body 1, or positioned in one of the transverse positioning grooves 151 and supported on the support bar 2 in one of a series of tilted condition, or rested in the recessed wall 16 and stopped between the stop plate 141 and the support bar 2 in a tilted position.

Although a particular embodiment of the invention has been described in detail for purposes of illustration, various modifications and enhancements may be made without departing from the spirit and scope of the invention. Accordingly, the invention is not to be limited except as by the appended claims.

What the invention claimed is:

1. A support rack, comprising:
a rack body comprising a base member, said base member comprising opposing inner wall and outer wall, at least one coupling structure located at said outer wall, a locating groove located at said outer wall at a front side relative to said at least one coupling structure, first positioning means disposed in a middle part of said locating groove, and second positioning means located at said outer wall near a rear side thereof; and
a support bar receivable in said locating groove of said rack body, said support bar comprising at least one axle-shaped end portion respectively pivotally coupled to said at least one coupling structure and turnable relative to said rack body in and out of said locating groove of said rack body for supporting a mobile electronic device in a tilted position to let said mobile electronic device be selectively stopped against one of said first positioning means and said second positioning means.

2. The support rack as claimed in claim 1, wherein said base member of said rack body comprises a bottom panel, a cover panel covering said bottom panel, and a recessed accommodation space surrounded by said bottom panel and said cover panel; the support rack further comprises a fan module mounted in said recessed accommodation space.

3. The support rack as claimed in claim 2, wherein said fan module comprises a fan bracket mounted in said recessed accommodation space of said rack body and an electric fan mounted in said fan bracket, said electric fan comprising a power cable extending out of said fan bracket and terminating in an electrical plug connector electrically connectable to a power jack of a mobile electronic device for power input, said fan bracket comprising a plurality of air vents, an accommodation open chamber located at a back side thereof and adapted for accommodating said power cable and a pivoted lid movable to close and open said accommodation open chamber.

4. The support rack as claimed in claim 1, wherein said outer wall of said base member of said rack body is a recessed wall sloping down from a back side of said base member toward a front side of said base member.

5. The support rack as claimed in claim 1, wherein said bottom panel of said base member is covered with a cushion layer, said cushion layer being selected from the group of high elastic breathing fabric, ethylene vinyl acetate (EVA), polyurethane (PU) and silicon rubber.

6. The support rack as claimed in claim 1, wherein each said coupling structure of said rack body comprises an axle groove transversely located at one end of said locating groove, and two stub pivot rods suspending in said axle groove at two opposite ends of said axle groove and facing toward each other; said support bar is a substantially U-shaped bar fitting said locating groove of said rack body, comprising one said axle-shaped end portion at each of two distal ends thereof, each said axle-shaped end portion comprises an axle hole pivotally coupled to the two stub pivot rods of one said coupling structure.

7. The support rack as claimed in claim 6, wherein each said coupling structure of said rack body further comprises a retaining hole disposed in a bottom side of the axle groove thereof; said support bar further comprises a locating rib protruded from each said axle-shaped end portion and engageable into said retaining hole of one respective said coupling structure.

8. The support rack as claimed in claim 1, wherein said locating groove of said base member of said rack body is a substantially U-shaped locating groove; said support bar is a substantially U-shaped bar fitting said U-shaped locating groove of said base member; said base member comprises a plurality of air vents arranged between the first positioning means and the second positioning means.

9. The support rack as claimed in claim 1, wherein said first positioning means comprises a positioning recess located at a middle part of said locating groove of said base member of said rack body, and a stop plate hinged to said base member of said rack body and movable in and out of said locating groove of said base member of said rack body within a predetermined angle.

10. The support rack as claimed in claim 1, wherein said second positioning means comprises a plurality of transverse positioning grooves located at said outer wall of said base member of said rack body and spaced from said first positioning means at different distances.
